(19) United States
(12) Patent Application Publication
(10) Pub. No.: US 2023/0081406 A1
(43) Pub. Date: Mar. 16, 2023

(54) Multi-Bit Drill Chuck Adaptor

(71) Applicants: Ricardo Valdez, Renton, WA (US); Diego Gonzalez, Renton, WA (US)

(72) Inventors: Ricardo Valdez, Renton, WA (US); Diego Gonzalez, Renton, WA (US)

(21) Appl. No.: 17/901,665

(22) Filed: Sep. 1, 2022

Related U.S. Application Data
(60) Provisional application No. 63/245,006, filed on Sep. 16, 2021.

(51) Int. Cl. B25F 3/00

(52) U.S. Cl. CPC B25F 3/00; B25B 21/007

(57) ABSTRACT

An adaptor head mountable in a drill chuck, the chuck adaptor head having interchangeable tool bits for efficiently performing drill and drive operations that require an assortment of bits. A quick change of bits is realized by mounting each bit in a pivotable yoke cradle that guides the bit from a “head-up detent position” to an “head-down” active position” when needed, eliminating the need for chucking and unchucking of bits. In a first embodiment, the chuck adaptor head is configured to mount four or more bits on yoke cradle members for rapid, uninterrupted use by rotating the bits in and out of a driver socket at the end of a rotating spindle.

### CROSS REFERENCE TO RELATED APPLICATIONS

This application is related to and claims priority to U.S. Provisional Patent No. 63/245,006 entitled “Multi-Bit Drill Chuck Adaptor”, filed Sep. 16, 2021, which is herein incorporated in full by reference for all purposes.

### TECHNICAL FIELD

This disclosure pertains generally to the field of solutions for increasing the efficiency of interchanging tool bits on rotary drills.

### BACKGROUND

A variety of tools are used at jobsites and in projects by carpenters, mechanics and hobbyists for tightening, securing and loosening various fasteners. Screws or bolts are used instead of nails or staples in many applications. A power drill speeds up much of this work, and is faster than a ratchet wrench, but the variety of fastener types in common use requires that a mating tool bit compatible with each fastener type be inserted into the drill chuck prior to use. The process of chucking and unchucking must be repeated for each type of fastener, reducing speed and efficiency.

Reversible drill chuck adaptors, such as are illustrated in U.S. Pat. No. 1,697,414 to Cordray, U.S. Pat. No. 4,676,703 to Swanson, U.S. Pat. No. 5,785,468 to Peritz, U.S. Pat. No. 6,877,937 to Hsiao, U.S. Pat. No. 7,237,937 to Hernandez and U.S. Pat. No. 8,739,340 to Jagosh, demonstrate that this problem has attracted generations of inventors. The typical solution is a reversible combination of drill and driver.

But more complex jobs are expected to benefit from more flexibility than can be provided with just two tool bits. And there may be unexpected benefits if the drill chuck adaptor body does not revolve with the drill chuck and tool bit. These and other considerations led to the solution disclosed here.

### SUMMARY

Disclosed is an adaptor head with rotating shaft that mounts in a conventional drill chuck. The adaptor head includes a body member of a generally cylindrical shape (termed here an “adaptor head block”) with axial slots cut for receiving each a yoke assembly (termed here a “yoke cradle”) with tool bit. The adaptor head includes a plurality of selectable tool bits and means for pivoting each of the tool bits onto a driver socket at the base of the rotating shaft, so that torque from the drill can be applied to a fastener engaged on the tool bit, while the adaptor head does not rotate.

The invention includes a centered, hexagon-shaped drive shaft with chuck spindle that can be attached to any conventional drill chuck. As currently practiced, each selected tool bit is inserted into a yoke cradle that can be reversibly pivoted so that the tool bit rotates from a head-up detent position to a head down active position in which power can be applied to a fastener. Only one tool bit at a time can be in the active position, but each tool bit can be quickly exchanged for another using the fingers of one hand rather than a chuck tool.

The drive shaft includes a top spindle end that mounts in the drill chuck and a bottom driver socket end that receives a mating butt end of the tool bit. The driver socket inside the base of the adaptor head block is formed with internal flats or facets that prevent slippage of the tool bit during rotation and may include a magnetic interface. The tool bit is loosely held in a yoke cradle that allows axial rotation with torque. The yoke cradle includes a pivot pin, and the rotation of the yoke cradle on the pivot pin guides the tool bit from the head-up to the head-down position. The dimensions of the yoke cradle and pivot pin are designed so that at one end of the yoke cradle's rotational arc, the tool bit is standing head-up in a detent clip on a circumferential wall of the adaptor head body, and at the other end of the yoke cradle's rotational arc, the tool bit is seated head-down in a driver socket end of the rotating shaft. The butt end of the tool bit is seated in the driver socket so that torque from the drill can be transferred to a fastener on the working tip of the tool bit, such as a screw for example, that seats on a male screw head of the tool bit. Similarly, the tool bit selection may include one or more twist drills for making various hole diameters (such as guide holes for starting screws), and driver heads selected from Allen heads, Phillips heads, Star head drivers, and slotted head drivers, for example. Tool bits may also include socket adaptors for use with nuts and bolts, while not limited thereto.

### BRIEF DESCRIPTION OF THE DRAWINGS

The elements, features, steps, and advantages of one or more embodiments will be more readily understood upon consideration of the following detailed description, taken in conjunction with the accompanying drawings, in which embodiments, including details, conceptual elements, and current practices, are illustrated by way of example.

It is to be expressly understood, however, that the drawings are for illustration and description only and are not intended as a definition of the limits of the embodiments and conceptual basis as claimed. The various elements, features, steps, and combinations thereof that characterize aspects of the claimed matter are pointed out with particularity in the claims annexed to and forming part of this disclosure. The invention(s) do not necessarily reside in any one of these aspects taken alone, but rather in the invention(s) taken as a whole.

One or more embodiments are taught and are more readily understood by considering the drawings in association with the specification, in which:

FIG. 1 is a first perspective view of a drill chuck adaptor head 100 fitted with four tool bits.

FIG. 2 illustrates the engagement of a spindle of the adaptor head with a drill chuck.

FIG. 3 is a first exploded view showing the tool bits in their pivotable yoke cradles.

FIGS. 4A and 4B are plan and exploded plan views looking up from under the adaptor head.

FIGS. 5A and 5B are plan and exploded plan views looking down from above the adaptor head.

FIG. 6 is an action view showing the rotation of a yoke cradle and tool bit in the yoke cradle guide slots formed in the adaptor head body.

FIGS. 7A and 7B are perspective views of the adaptor head with an assortment of tool bits.

FIG. 8 and FIG. 9 isolate the drive shaft and yolk cradle to show how the tool bit is rotated so that the butt end seats into the driver socket at the base of the drive shaft during use. FIG. 9 shows the rotational action of the yoke cradle on its pivot axis.

FIG. 10 is another view of the rotational action of the yoke cradle, showing how the butt end of the tool bit is inserted into the driver socket of the drive shaft.

FIG. 11 is a cutaway view of the adaptor head block to show the bushing wall within which the yoke cradle rotates.

FIG. 12 is a sectional view of the driven shaft with driver socket and a magnetic insert.

FIG. 13 is a perspective view to illustrate the pivot action of the yoke cradle in the yoke cradle guide slot. Shown here is a tool bit fashioned as a twist drill.

FIG. 14 illustrates the adaptor head with the twist drill in the active position and three other tool bits in their detent clips.

FIG. 15 illustrates an assortment of tool bits useable with the adaptor head.

FIG. 16 is a view of an extension shank usable with other tool bits to lengthen the reach of the bit.

FIG. 17 demonstrates how the tool bits can be swapped out depending on the needs of the job.

The drawing figures are not necessarily to scale. Certain features or components herein may be shown in somewhat schematic form and some details of conventional elements may not be shown in the interest of clarity, explanation, and conciseness. The drawing figures are hereby made part of the specification, written description and teachings disclosed herein.

### GLOSSARY

Certain terms are used throughout the following description to refer to particular features, steps, or components, and are used as terms of description and not of limitation. As one skilled in the art will appreciate, different persons may refer to the same feature, step, or component by different names. Components, steps, or features that differ in name but not in structure, function, or action are considered equivalent and not distinguishable, and may be substituted herein without departure from the spirit and scope of the disclosure. The following definitions supplement those set forth elsewhere in this specification. Certain meanings are defined here as intended by the inventors, i.e., they are intrinsic meanings. Other words and phrases used herein take their meaning as consistent with usage as would be apparent to one skilled in the relevant arts. In case of conflict, the present specification, including definitions, will control.

Unless otherwise defined, all technical and scientific terms used herein have the same meaning as commonly understood by one of ordinary skill in the art to which the subject matter described herein belongs.

In case of conflict, the present specification, including definitions, will control.

General connection terms including, but not limited to “connected,” “attached,” “conjoined,” “secured,” “mounted” and “affixed” are not meant to be limiting, such that structures so “associated” may have more than one way of being associated.

Relative terms should be construed as such. For example, the term “front” is meant to be relative to the term “back,” the term “upper” is meant to be relative to the term “lower,” the term “vertical” is meant to be relative to the term “horizontal,” the term “top” is meant to be relative to the term “bottom,” and the term “inside” is meant to be relative to the term “outside,” and so forth. Unless specifically stated otherwise, the terms “first,” “second,” “third,” and “fourth” are meant solely for purposes of designation and not for order or for limitation. Reference to “one embodiment,” “an embodiment,” or an “aspect,” means that a particular feature, structure, step, combination or characteristic described in connection with the embodiment or aspect is included in at least one realization of the inventive matter disclosed here. Thus, the appearances of the phrases “in one embodiment” or “in an embodiment” in various places throughout this specification are not necessarily all referring to the same embodiment and may apply to multiple embodiments. Furthermore, particular features, structures, or characteristics of the inventive matter may be combined in any suitable manner in one or more embodiments. For example, it is contemplated that features of dependent claims depending from one independent claim can be used in apparatus and/or methods of any of the other independent claims.

“Adapted to” includes and encompasses the meanings of “capable of” and additionally, “designed to”, as applies to those uses intended by the patent. In contrast, a claim drafted with the limitation “capable of” also encompasses unintended uses and misuses of a functional element beyond those uses indicated in the disclosure. Aspex Eyewear v Marchon Eyewear 672 F3d 1335, 1349 (Fed Circ 2012). “Configured to”, as used here, is taken to indicate is able to, is designed to, and is intended to function in support of the inventive structures, and is thus more stringent than “enabled to”.

As used herein, the terms “include” and “comprise” are used synonymously, the terms and variants of which are intended to be construed as non-limiting.

It should be noted that the terms “may,” “can,” and “might” are used to indicate alternatives and optional features and only should be construed as a limitation if specifically included in the claims.

The various components, features, steps, or embodiments thereof are all “preferred” whether or not specifically so indicated. Claims not including a specific limitation should not be construed to include that limitation. For example, the term “a” or “an” as used in the claims does not exclude a plurality.

“Conventional” refers to a term or method designating that which is known and commonly understood in the technology to which this disclosure relates.

Unless the context requires otherwise, throughout the specification and claims that follow, the term “comprise” and variations thereof, such as, “comprises” and “comprising” are to be construed in an open, inclusive sense—as in “including, but not limited to.”

The appended claims are not to be interpreted as including means-plus-function limitations, unless a given claim explicitly evokes the means-plus-function clause of 35 USC § 112 para (f) by using the phrase “means for” followed by a verb in gerund form.

A “method” as disclosed herein refers to one or more steps or actions for achieving the described end. Unless a specific order of steps or actions is required for proper operation of the embodiment, the order and/or use of specific steps and/or actions may be modified without departing from the scope of the present disclosure.

### DETAILED DESCRIPTION

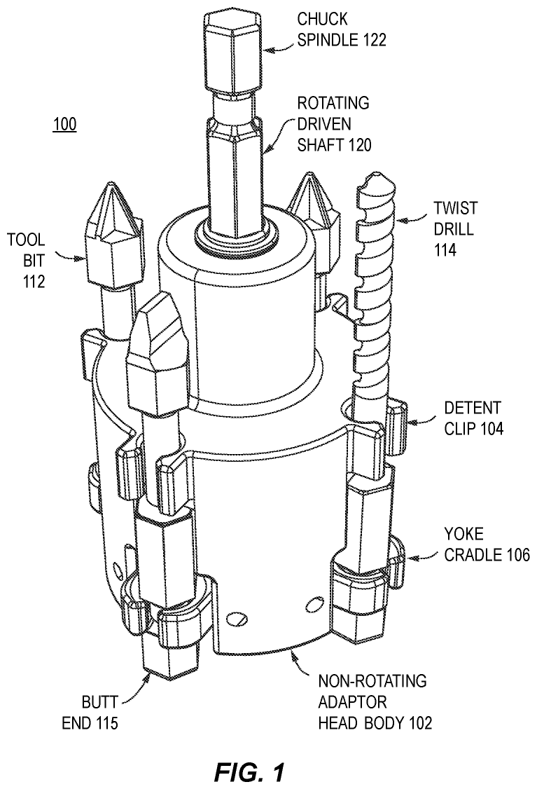

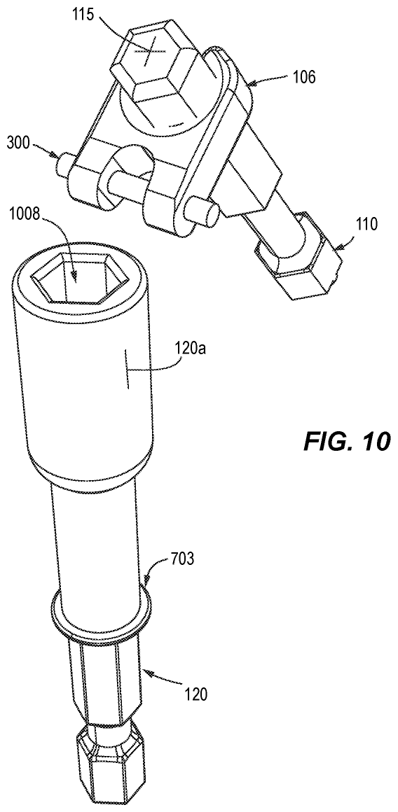

FIG. 1 is a first perspective view of a drill chuck adaptor head 100 fitted with four tool bits. The head includes a non-rotating body member 102 that is fitted with four detent clips 104 and four yoke cradle assemblies 106, each with a tool bit. A selection of tool bits are shown here; exemplary tool bits that may be used include Phillips head driver 112 and twist drill 114 (as used here generically 110, “tool bit”). Each tool bit is formed with a butt end 115 that seats in a driver socket (FIG. 10, 1008)

The non-rotating body 102 receives a rotating driven shaft 120 that attaches via a spindle 122 to a drill chuck 124. The chuck 199 attaches via a conventional chuck shank to a conventional drill power tool and is not part of the adaptor head 100.

The rotating driven shaft 120 is mounted in a journalled axial cavity in the adaptor head block 102. The shaft may be slip fitted or may be mounted with bearings to reduce rotational friction.

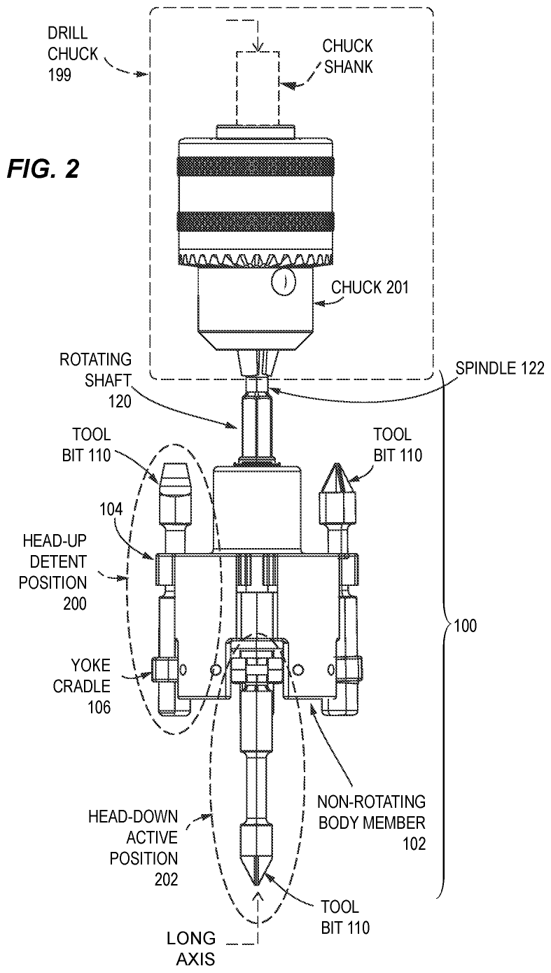

FIG. 2 illustrates the engagement of a spindle of the adaptor head 100 with a drill chuck 201 and demonstrates that the tool bits 110 can have two positions, one a “head up detent position” (200) in which the bits are in their detent clips 104, and the other a “head down active position” (202) in which the butt end a tool bit is engaged to deliver torque from the rotating shaft 120 to the workpiece (not shown).

In more detail, the adaptor head block 102 is an elongate cylindrical head member with long axis, outside wall, and axial cavity for receiving a center driven shaft member 120 that rotates on a slip-fitted or bushing surface inside the cylindrical head on the long axis of the drill chuck. The central shaft has a spindle end at the top that is configured to be engaged in the chuck of a power drill. At the bottom end of the driven shaft is a driver socket that is configured to engage any one of multiple interchangeable bits.

The driver socket (1008, FIG. 10) is recessed in the central shaft member and is faceted on its inside face to prevent slippage of the bits during rotation. A magnetic insert may be disposed at the base of the recessed drive socket so as to facilitate seating of the bits. The bits are mounted in retaining clips on the outside wall of the cylindrical body and pivot in yoke cradles from a detent “head-up” position to an active “head-down” position. In the active position, the driver socket engages the bit such that rotation of the shaft results in torque being transferred from the power drill to the bit, and from the bit to a fastener such as screw or bolt. In another action, the bits may be interchanged by toggling the yoke cradles so that the drive socket engages a second bit. Two, three or more bits may be mounted on the circumference of the adaptor head and selectively engaged on the driver socket.

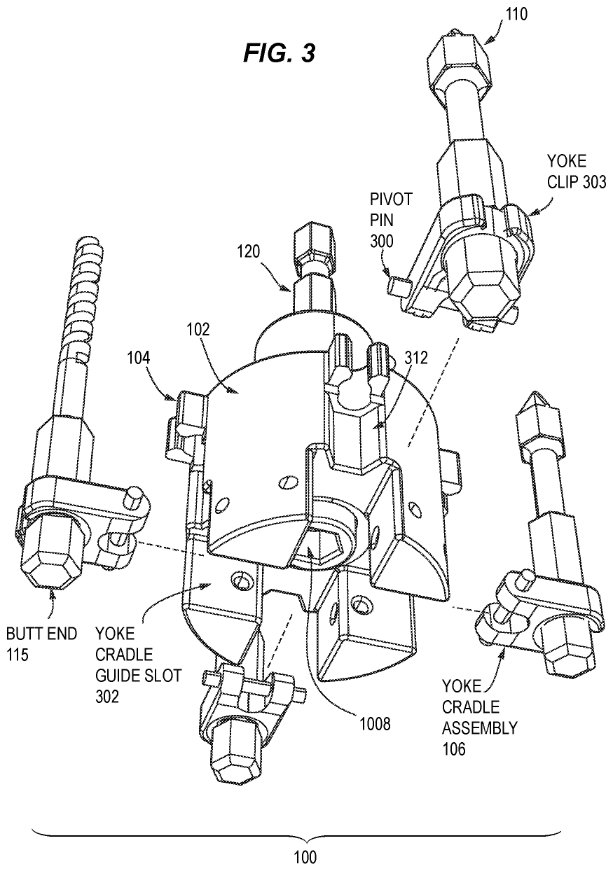

FIG. 3 is a first exploded view showing the tool bits 110 in their pivotable yoke cradles 106. As presently practiced, pivot pins 300 insert into holes in the walls of yoke cradle guide slots 302 and define a pivot axis on which the yoke cradle swings between the head up 200 and the head down position 202. Other pivot means are contemplated. When the tool bits are in the head-up position, the tool is secured by detent clips 104 against the outside cylindrical wall of the adaptor head body 102. The tool bits are secured to the yoke cradle assemblies 106 with yoke clips 303.

Four yoke cradle guide slots 302 are formed in the adaptor head body 102 as shown. However, the number of guide slots is not limited to four. Three guide slots or six guide slots can be implemented using the same body plan.

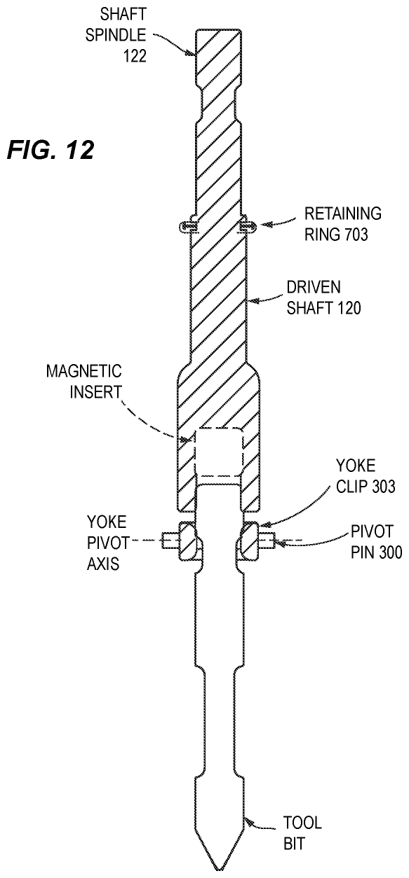

Butt end 115 of each tool bit fits into the driver socket (1008, FIG. 10) of the rotating shaft 120. The hexagonal butt end of the tool bit engages the driver socket at an essentially vertical tangent to the rotational arc of the bit around pivot pin 300, and seats in the hexagonal well 1008 with sufficient tightness that the internal faces of the driver socket prevent slippage of the tool bit during use. A magnet may also be used to facilitate engagement as described in FIG. 12. Other geometries could be used, but the faces of a hexagon are both slip resistant and permit a looser tolerance that makes the bits easy to switch.

Detent clips 104 may be formed of a resilient material so as to allow the waist of the tool bit to snap in place when not in use. The adaptor head body may be made of a molded plastic solid, or may be machined from metal, for example. As shown here, the detent clip 104 sits at the top of a chamfered slot 312 that merges into the yoke cradle guide slots 302 for a more compact footprint, and the adaptor head block 102 is formed with four triangular sections with drill holes for insertion of the pivot pins 300. In other embodiments, the yoke cradle includes molded or machined side lugs that slide into dead ended channels in the walls of the yoke cradle guide slots. By forming flats on the lugs, the individual yoke cradles can be held in place but then rotated and slid out for replacement if necessary.

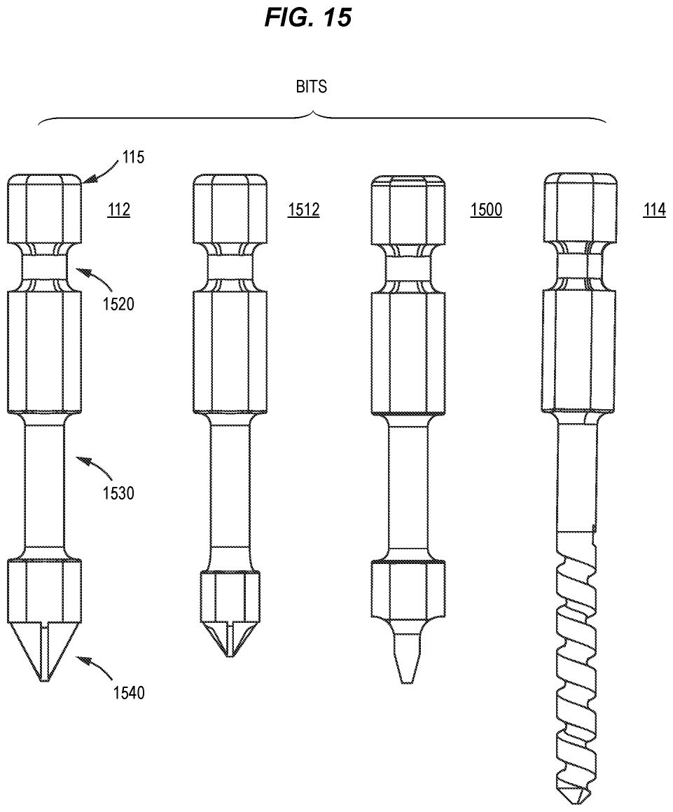

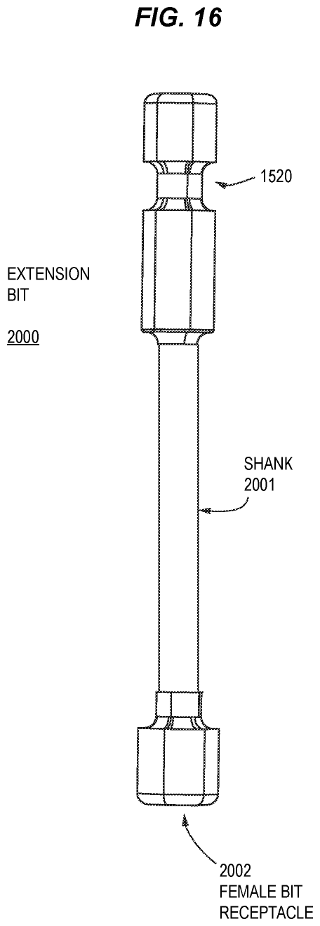

Individual tool bits 110 are not captive in the yoke cradles, but may be exchanged as described in FIG. 16. Exemplary tool bits are shown in FIG. 15 and will be described in more detail below.

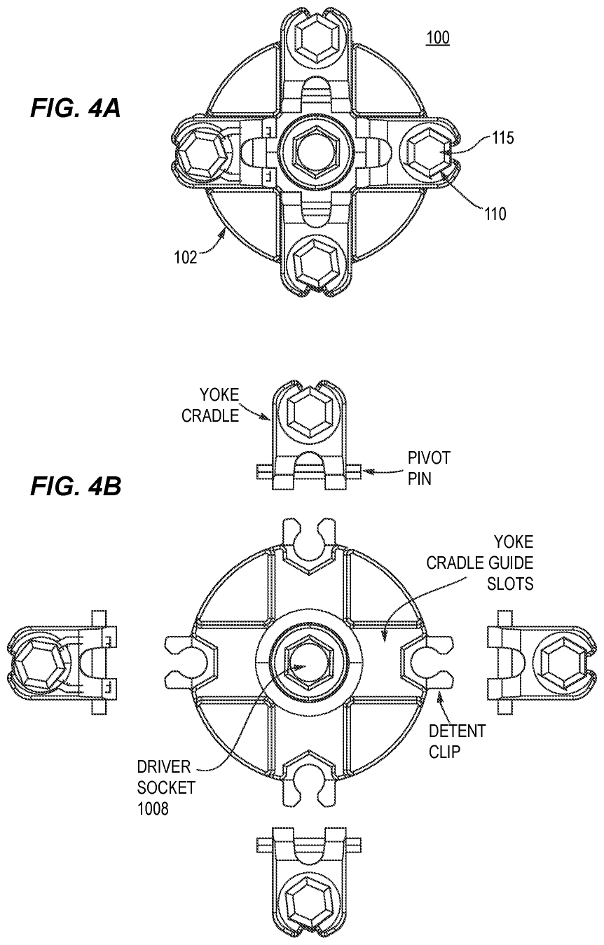

FIGS. 4A and 4B are plan and exploded plan views looking up from under the adaptor head 100. The rotating driver socket 1008 at the center is a female recessed socket with hex walls that receives the hexagonal butt ends 115 of the tool bits. The four triangular segments of the base of the adaptor head block 102 are readily visible in this view.

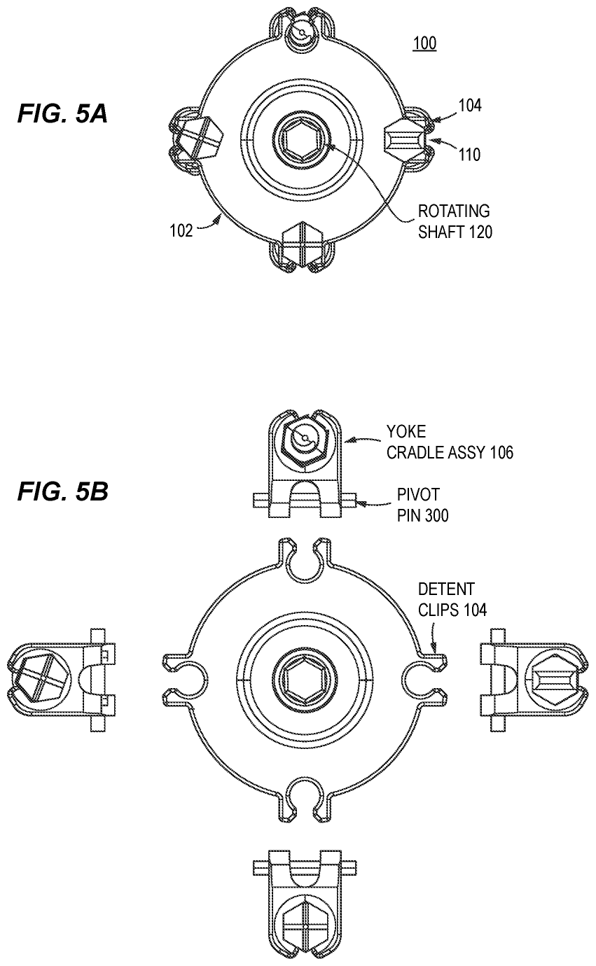

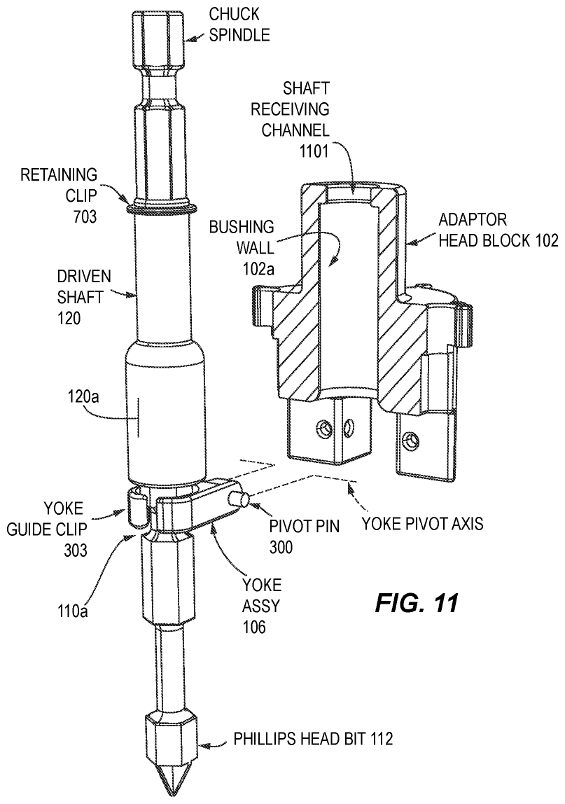

FIGS. 5A and 5B are plan and exploded plan views looking down from above the adaptor head 100. The tool bits are in the head-up position in which the working ends of a tool assortment are shown in plan view. The center drive shaft member 120 rotates on the long axis of the drill chuck. It rotates on a bushing surface inside the cylindrical body of the adaptor head as will be described with reference to FIG. 11 below.

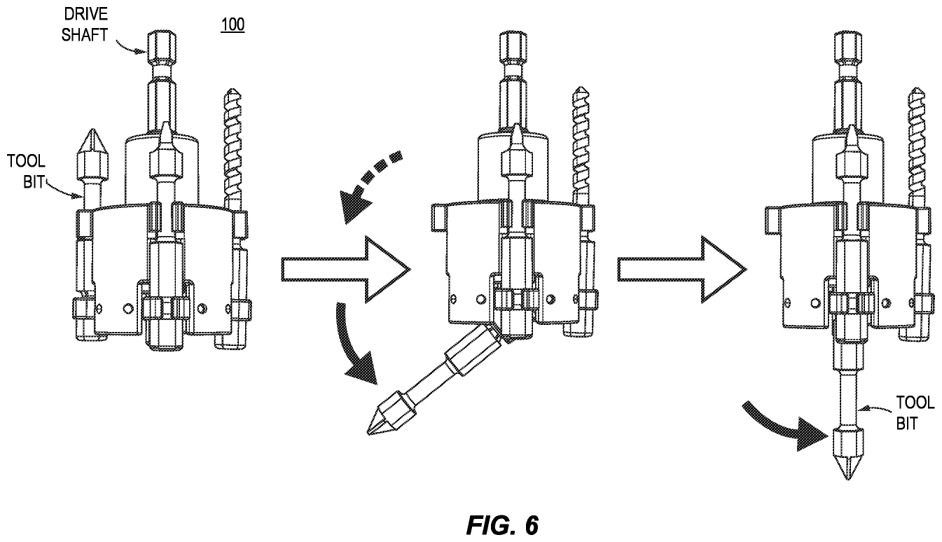

FIG. 6 is an action view showing the rotation of a tool bit in the yoke cradle guide slots formed in the adaptor head 100. The yoke cradle is being rotated on a pivot axis that extends perpendicular to the plane of view. At the bottom of the rotation, the butt end 115 of the tool bit finds the driver socket 1008 of the drive shaft 120. This rotational motion is completely reversible and also applies to any of the three other tool bits depicted. Action is indicated by bold solid arrows. Transition states are indicated by bold outlined arrows.

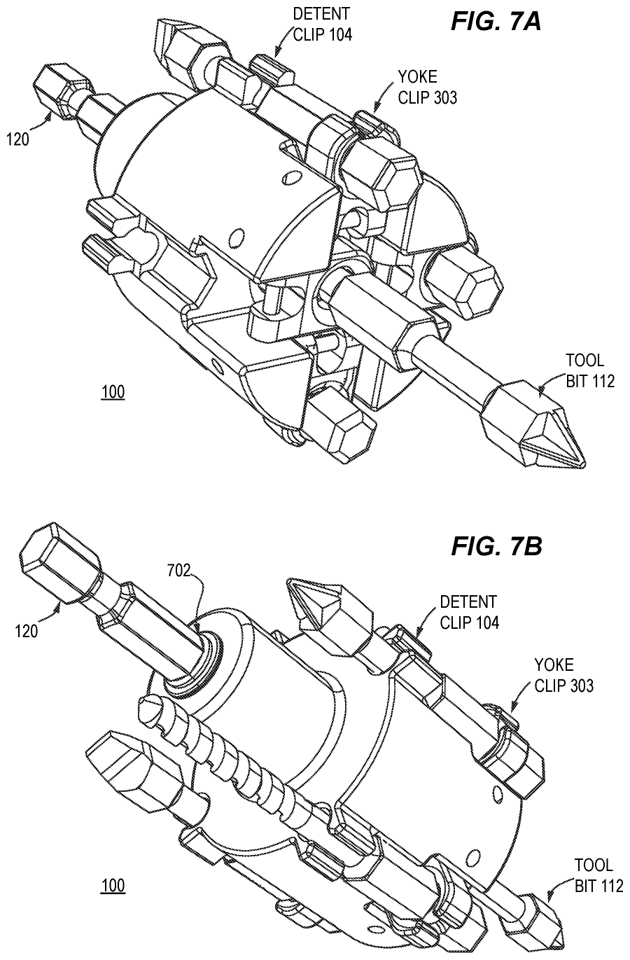

FIGS. 7A and 7B are perspective views of the adaptor head 100 with an assortment of tool bits. In FIG. 7A, tool bit 112 is completely inserted into the driver socket 1008 (center, FIG. 10) and the yoke cradle is flipped when the bit is in the head-down active position 202. The remaining tool bits are in the head-up detent position 200 (FIG. 2). In the perspective view of FIG. 7B, the adaptor head is rotated so that the head-up tool bits are in the foreground, and tool bit 112 points toward the vanishing point. This view also shows a retaining clip or ring 702 that fits around the driving shaft and prevents the adaptor head body member from sliding up the shaft into the drill chuck during use.

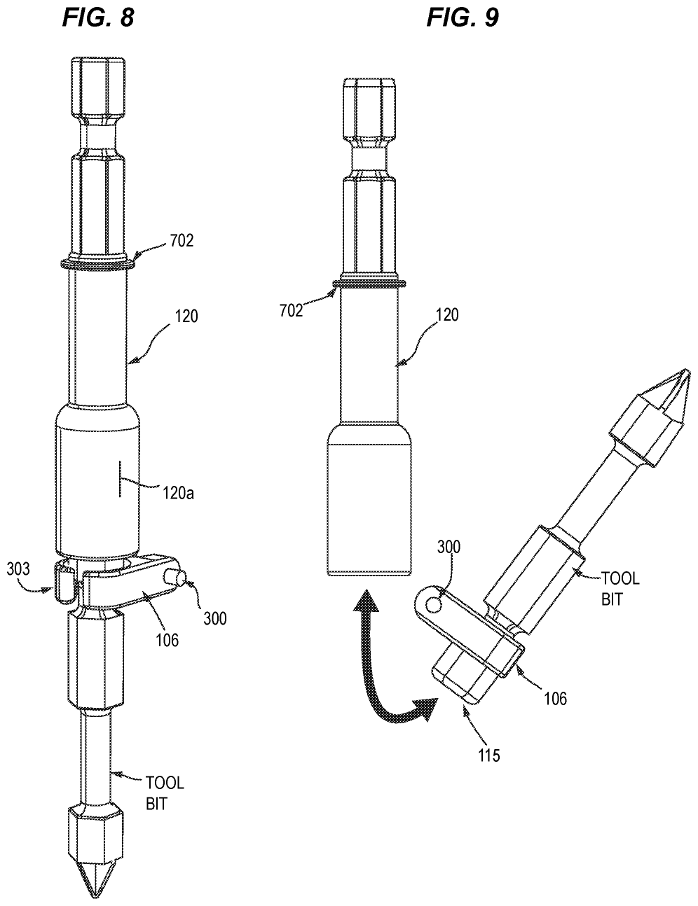

FIG. 8 and FIG. 9 isolate the drive shaft and yolk cradle to show how the tool bit is rotated so that the butt end seats into the driver socket at the base of the drive shaft during use. FIG. 9 shows the rotational action of the yoke cradle on its pivot axis. The pivot axis is defined by pivot pin 300 which is seated crosswise in the yoke cradle guide slot 302 (FIG. 3) and is at a distance from the long axis of rotation that precisely mates the tool bit to the driver socket when the tool bit is pointed down toward the workpiece.

Shaft 120 includes a bulbous cylindrical section 120a that rides on the journalled interior wall (102a, FIG. 11) of the adaptor head block (102, FIG. 11) and aligns the rotary motion of the tool bit with the long axis of the drill chuck. The surface may be lubricated with graphite or oil for smooth operation, or may be made of a self-lubricating material. In some instances, a bearing surface is inserted over the bushing wall, for example a thrust ring of needle bearings to minimize friction under load for high performance applications.

FIG. 10 is another view of the rotational action of the yoke cradle assembly 106, showing how the butt end 115 of the tool bit 110 is inserted into the driver socket 1008 of the drive shaft 120. Pivot pin 300 is again shown, and inserts at the pivot axis in the adaptor head body member 102 as can be seen in FIG. 11. Retaining ring or clip 703 is drawn where it seats further up the shaft.

The cylindrical section 120a can be seen to be dimensioned so that the driver socket 1008 is disposed in the solid shaft as a well with hexagonal sides. While the pivot pin appears to float in space in this isolated view, it is at a point designed so that counterclockwise rotation of the yoke cradle brings the butt end of the tool bit into socket 1008.

FIG. 11 is a cutaway view (hatched face) of the adaptor head block 102 to show the journalled bushing wall 102a within which the driven shaft wall 120a rotates. This is termed the “shaft receiving channel” 1101. The shaft is restrained in the vertical axis by retaining clip 703 and by a lip at the base of the shaft receiving channel 1101. Also shown are insertion points for the yoke cradle pivot pins 300. In this view, the tool bit includes a waist 110a where the yoke clips seat. The waist 110a and yoke clips 303 are dimensioned with tolerances so that the tool bit can seat in the driver socket and not be hindered in rotating by the yoke clips 303 while nonetheless providing support during transit of the tool bits between the head-up and head-down positions.

FIG. 12 is a sectional view of the driven shaft 120 with top end chuck spindle 122 and bottom end driver socket 1008. Also shown in section is a diamagnetic insert used to improve the self-seating of the tool bit in the driver socket. The position of the tool bit and the yoke assembly with yoke clip 303 and pivot pin 300 are shown for reference.

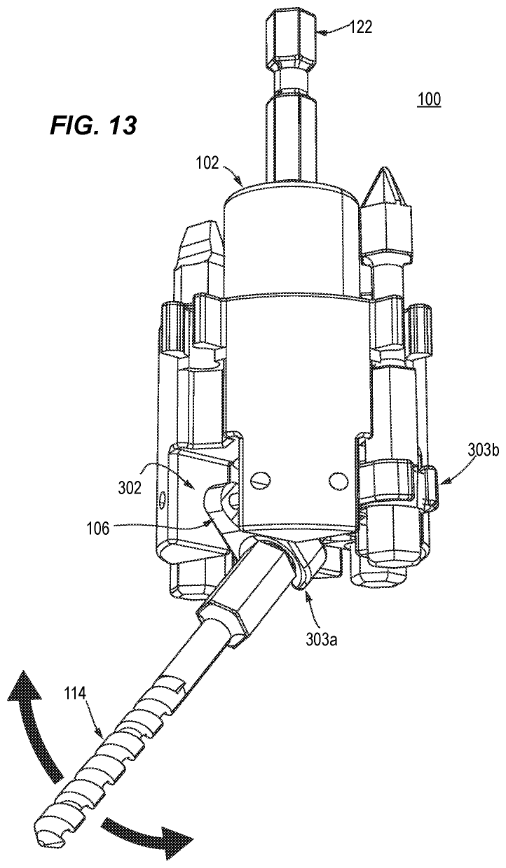

FIG. 13 is a perspective view to illustrate the pivot action of the yoke cradle in the yoke cradle guide slot. Shown here is a tool bit fashioned as a twist drill 114. Bold arrows indicate the guided motion of the yoke cradle assembly 106 and yoke clip 303a on its pivot pin 300 (FIG. 10). For comparison, yoke clip 303b is shown in the “head-up position” (200). The motion of yoke clips 303a is a 180 degree rotation from the head-up position to the head down position (202).

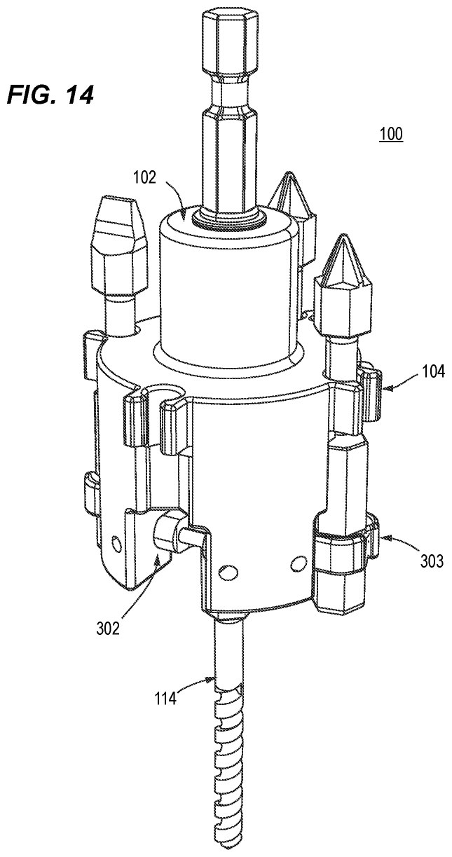

FIG. 14 illustrates the adaptor head with the twist drill 114 in the active position (202) and three other tool bits in their detent clips. Because the adaptor head block does not spin with the driven shaft, the detent clips may be loosely fitted to the tool bits so that they can be more easily released with a tug of a finger but are compactly installed on the exterior surface of the adaptor head block 102. The adaptor head block is formed with a first circumference at the level of the yoke cradle clips 303 and a smaller circumference above the detent clips 104 to allow clearance for a variety of tool bit heads.

FIG. 15 illustrates an assortment of tool bits 112, 1512, 1500, and 114 useable with the adaptor head. Strictly for illustration, a large Phillips head driver 112 and a smaller Phillips head driver 1512 are shown. Also shown is a flat bladed driver 1500 and a twist drill 114. As currently practiced, several generic features are evident. The profiles of the tool bits include a butt end 115 for insertion into the driver socket and a tapered waist 1520 below that. The butt end 115 of each tool bit is radiused so as to be self-aligning when forced up against the driver socket 1008. The tapered waist 1520 is captive in the yoke clips 303 of the yoke cradle 106 during use. Another tapered section 1530 is intended for easier insertion into the detent clips 104. Each tool bit terminates in a head-down working end 1540. The relative lengths of the tools are designed according to the overall dimensions of the chuck spindle 122 length relative to the cylindrical body 102 height and may be altered to suit the application. A socket driver extension may be provided as part of a kit to permit the user some flexibility in selecting a working length.

FIG. 16 shows an extension shaft 2000 with long shank 2001 that can be mounted in a yoke cradle 106 on the adaptor head 100, and provides the user with the capacity to insert a bit into the female end 2002 for a longer reach, when rotated into the active position on the adaptor head. The female end of the extension shaft is formed with a distal driver socket of the same inside hex dimensions as driver socket 1008. This extension piece is useful when working in corners, under counters, or around doorknobs, for example.

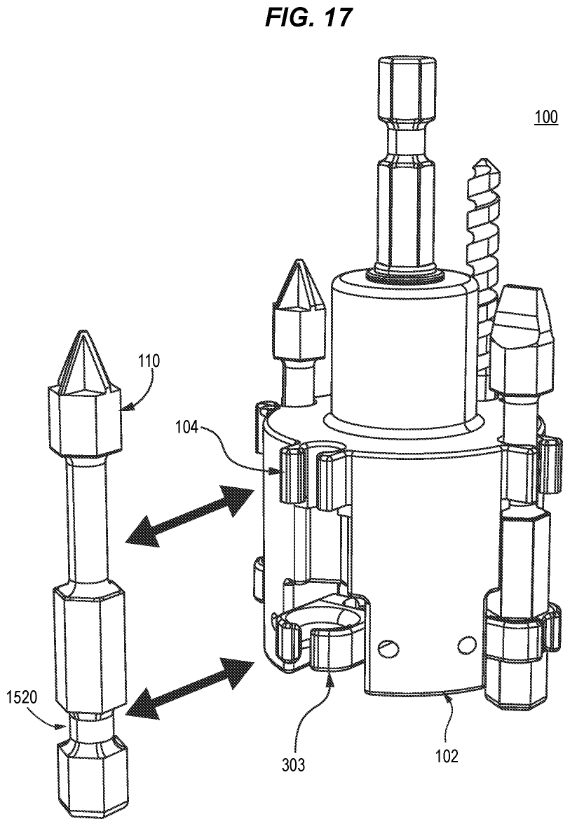

FIG. 17 demonstrates how the tool bits 110 can be swapped out of the adaptor head 100 depending on the needs of the job. Each tool bit can be individually selected and installed in one of the yoke clips 303 and one of the detent clips 104. The tool bit is then ready to be rotated to the head down active position whenever it is needed.

It is contemplated that articles, apparatus, methods, and processes that encompass variations and adaptations developed using information from the embodiments described herein are within the scope of this disclosure. Adaptation and/or modification of the articles, apparatus, methods, and processes described herein may be performed according to these teachings.

### Example I

In other embodiments, a quick change of bits is enabled by forming circumferentially-positioned axial slots for 3, 4, 5 or even 6 bits, each with a yoke cradle that pivots each bit from a detent position to an active position when needed.

### Example II

In an embodiment, the adaptor head block includes a radially disposed arm that functions as a handle for stabilizing the tool during use. The radial handle extends from the adaptor head between any two of the circumferentially positioned axial slots and may be removable when not needed.

### Example III

In an embodiment, the drive socket includes a permanent magnet, and the tool bits are made of a paramagnetic material that becomes magnetized when the bit is pivoted into the drive socket. The magnetized tool bit causes ferrous fasteners such as self-tapping screws to stick to the tip of the tool bit so as to facilitate the user's efforts to accurately position the screw on a workpiece prior to beginning the driving operation.

### Example IV

In an embodiment, two twist drill bits and two Phillips head tool bits are mounted on the adaptor head. The bits are sized so that drill and drive operations for both larger and smaller screw fasteners are easily accomplished without unchucking and rechucking different-sized bits.

### Example V

The adaptor head may be fitted with a battery-powered lamp or lamps for illuminating a workpiece during use. The battery is inserted into the block of material that forms the body of the adaptor head and the lamp or LED is mounted on the bottom surface of the adaptor head and is supplied with an ON/OFF switch or button.

### Example VI

In other embodiments, the adaptor head is configured for mounting a tool bit that includes a snap-on socket wrench adaptor as is useful to mechanics. The tool bits may be a selection of commonly used sockets supplied either as one-piece tool bits, or as an adaptor that seats in the drive socket and is fitted with a square-drive connector that accepts interchangeable sockets of various sizes. When supplied as fixed socket sizes, each tool bit is selected for a particular sized bolt; when supplied with interchangeable sockets, the hex-shank adapter adapts the hex drive found on drill/drivers to the square snap-on format mechanics are familiar with. The socket adaptor is one of several tool bits that can be rotated into position on the adaptor head. Star and Allen head drivers may also be supplied as part of a kit of tool bits compatible with the adaptor head.

### Example VII

The tool is used in a method of making cabinets that requires alternation of bits.

### Example VIII

The tool includes underside receptacles for storing and accessing additional bits. Each of the additional bits may be swapped into one of the yoke cradles when needed.

### INCORPORATION BY REFERENCE

All of the U.S. Patents, U.S. Patent application publications, U.S. Patent applications, foreign patents, foreign patent applications and non-patent publications referred to in this specification and related filings are incorporated herein by reference in their entirety for all purposes.

### SCOPE OF THE CLAIMS

The disclosure set forth herein of certain exemplary embodiments, including all text, drawings, annotations, and graphs, is sufficient to enable one of ordinary skill in the art to practice the invention. Various alternatives, modifications and equivalents are possible, as will readily occur to those skilled in the art in practice of the invention. The inventions, examples, and embodiments described herein are not limited to particularly exemplified materials, methods, and/or structures and various changes may be made in the size, shape, type, number and arrangement of parts described herein. All embodiments, alternatives, modifications and equivalents may be combined to provide further embodiments of the present invention without departing from the true spirit and scope of the invention. It is intended that the scope of the invention be defined by the following claims and their equivalents as claimed here, while not precluding or prejudicing future applications having claims directed more broadly or more narrowly at the scope of the disclosure.

Any original claims that are cancelled or withdrawn during prosecution of the case remain a part of the original disclosure for all that they teach.

In general, in the following claims, the terms used in the written description should not be construed to limit the claims to specific embodiments described herein for illustration, but should be construed to include all possible embodiments, both specific and generic, along with the full scope of equivalents to which such claims are entitled. Accordingly, the claims are not limited in haec verba by the disclosure.

We claim:

1. A multi-bit chuck adaptor, which comprises
(a) an adaptor head block defined by an elongate cylindrical head member with long axis, outside wall, and a cylindrical axial cavity centered on the long axis of the block;
(b) a driven shaft member that rotates on a bushing surface inside the axial cavity;
(c) a spindle end of the shaft member at the top that is configured to be engaged in the chuck head of a power drill;
(d) a driver socket at the bottom end of the shaft member, wherein the driver socket that is configured to engage any one of multiple interchangeable bits;
(e) yoke cradle members disposed on a lower circumference of the adaptor head block, each yoke cradle assembly having yoke clips for securing a tool bit in the yoke cradle and a pivot axis designed to enable rotation of the tool bit from a head-up detent position to a head-down active position in which the tool bit can engage a workpiece.

2. The chuck adaptor of claim 1, wherein the driver socket is recessed in the central shaft member and is faceted on its inside face to prevent slippage of the bits during rotation.

3. The chuck adaptor of claim 1, wherein the drive socket is configured with a magnet that secures the bits in place within the socket.

4. The chuck adaptor of claim 1, wherein up to four interchangeable bits are mounted in retaining clips on the outside wall of the cylindrical body and pivot in yoke cradles from a detent “head-up” position to an active “head-down” position.

5. The chuck adaptor of claim 1, wherein the yoke cradle members are configured to pivot between an active position in which the driver socket engages a bit such that rotation of the shaft results in torque being transferred from the power drill to the bit, and a detent storage position in which the bit in the yoke cradle is disposed vertically against an outside wall of the adaptor head block.

6. The chuck adaptor of claim 1, wherein a first bit is interchangeable to a second bit in the driver socket by toggling the yoke cradles so that the drive socket engages the second bit.

7. The chuck adaptor of claim 6, wherein the second bit is interchangeable to a third bit in the driver socket by toggling the yoke cradles so that the drive socket engages the third bit.

8. The chuck adaptor of claim 7, wherein the third bit is interchangeable to a fourth bit in the driver socket by toggling the yoke cradles so that the drive socket engages the fourth bit.

9. The chuck head of claim 1, which comprises four yoke cradle members configured for receiving a selection of four bits at a time.

10. The chuck adaptor of claim 1, wherein the adaptor head block includes receptacles for accessibly carrying additional bits that are not engaged in the yoke cradles.

11. The chuck adaptor of claim 1, wherein the bits include an extension shaft mountable in a yoke cradle and rotatable into position by which a bit inserts in and is driven at a female end of the extension shaft at a greater distance from the chuck head.

12. The chuck adaptor of claim 1, further comprising a lateral arm disposed on the chuck adaptor body, the lateral arm is adapted to function as a handle.

13. The chuck adaptor of claim 1, wherein the adaptor head block is fitted with a lamp or lamps positioned to illuminate a work area; a battery power supply for the lamp or lamps, and an ON/OFF switch.

14. A method for using the chuck adaptor of claim 1, which comprises:
a) mounting the chuck adaptor spindle in the chuck head of a power drill;
b) mounting a selection of four bits in the yoke cradle members of the chuck adaptor;
c) rotating a first bit to engage the drive socket of the chuck adaptor; and,
d) powering the power drill to use the bit.

15. The method of claim 14, which comprises disengaging the first bit and engaging a second bit by rotating the second bit in a yoke cradle to engage the drive socket of the chuck adaptor.

16. The method of claim 14, which comprises disengaging the second bit and engaging a third bit by rotating the third bit in a yolk cradle to engage the drive socket of the chuck adaptor.

17. The method of claim 14, which comprises disengaging the third bit and engaging a fourth bit by rotating the fourth bit in a yolk cradle to engage the drive socket of the chuck adaptor.

18. The method of claim 14, which comprises interchangeably swapping out one or more bits from the yoke cradle members according to the needs of a task.

19. The method of claim 14, which comprises holding the adaptor head by a handle, said handle comprising a lateral arm extending from the chuck adaptor body.

20. The method of claim 14, which comprises removing the adaptor head from the drill chuck when not in use and re-attaching the adaptor head to the drill chuck when a multi-bit adaptor head is again needed.
